(19) United States
(12) Patent Application Publication
(10) Pub. No.: US 2015/0356794 A1
(43) Pub. Date: Dec. 10, 2015

(54) CONNECTED VEHICLE PREDICTIVE QUALITY

(71) Applicant: Ford Global Technologies, LLC, Dearborn, MI (US)

(72) Inventors: Kwaku O. Prakah-Asante, Commerce Township, MI (US); Manoharprasad K. Rao, Novi, MI (US); Jialiang Le, Canton, MI (US); Hsin-hsiang Yang, Ann Arbor, MI (US); Perry Robinson MacNeille, Lathrup Village, MI (US)

(21) Appl. No.: 14/297,520

(22) Filed: Jun. 5, 2014

(51) Int. Cl. G07C 5/00; G07C 5/08

(52) U.S. Cl. CPC G07C 5/008; G07C 5/0841

(57) ABSTRACT

A vehicle system includes a communication interface and a processing device. The processing device is configured to receive performance data associated with at least one of a plurality of vehicle subsystems and generate a message that includes the performance data. The communication interface is configured to transmit the message to a remote aggregation server. The remote aggregation server is configured to receive the performance data from multiple vehicles, aggregate the performance data, and identify a trend associated with various vehicle subsystems based at least in part on the performance data.

### BACKGROUND

Consumer products undergo rigorous tests for performance determination, reliability and robustness. While products are in the field various operational and user experiences are encountered. It may be advantageous to capture product performance continuously in the field, and provide predictive knowledge, to further enhance products and customers usage experiences.

### BRIEF DESCRIPTION OF THE DRAWINGS

FIG. 1 illustrates an example vehicle having an incorporated vehicle system for recording performance data associated with one or more vehicle subsystems and transmitting the performance data to a remote aggregation server.

FIG. 2 illustrates a block diagram of an example vehicle system and an example remote aggregation server.

FIG. 3 is a flowchart of an example process that may be used by the remote aggregation server of FIG. 1 to identify trends in the performance data relative to a group of vehicles.

### DETAILED DESCRIPTION

An example vehicle system includes a communication interface and a processing device. The processing device is configured to receive performance data associated with at least one of a plurality of vehicle subsystems and generate a message that includes the performance data. The communication interface is configured to transmit the message to a remote aggregation server. An example remote aggregation server is configured to receive the performance data from multiple vehicles, aggregate the performance data, and identify a trend associated with various vehicle subsystems based at least in part on the performance data. The trends may be used to determine which, if any, vehicle systems are prone to failure, which are operating as expected, which system features are used more often by consumers, etc. Thus, the remote aggregation server may identify issues associated with a particular vehicle subsystem that, e.g., only present during unusual use cases. The systems shown may take many different forms and include multiple and/or alternate components and facilities. The exemplary components illustrated are not intended to be limiting. Indeed, additional or alternative components and/or implementations may be used.

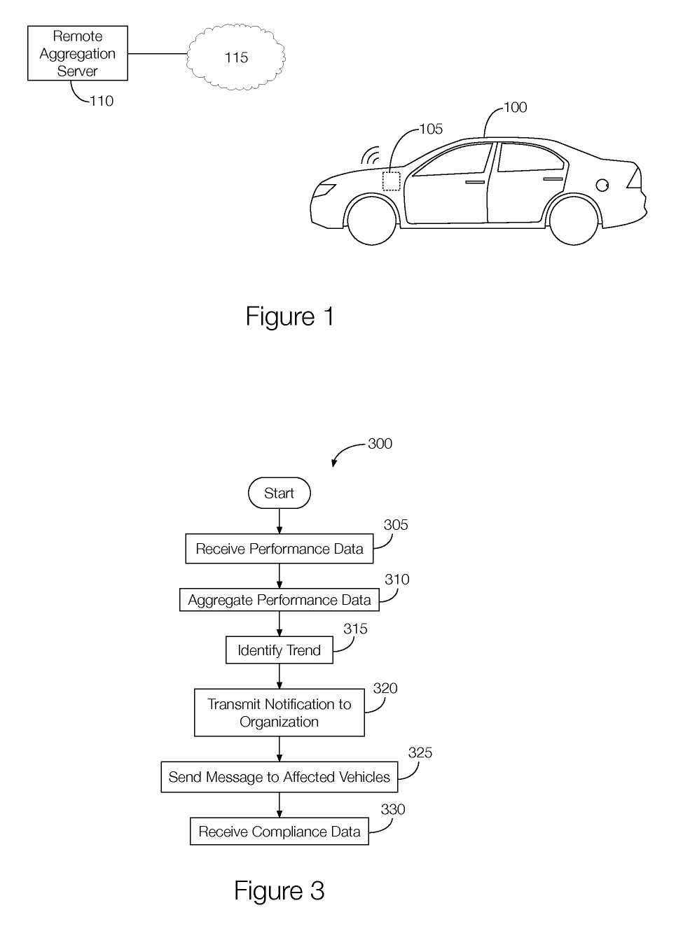

As illustrated in FIG. 1, the vehicle 100 includes a system 105 configured to measure and record performance data associated with one or more vehicle subsystems 125. The system 105 is configured to transmit the performance data to a remote aggregation server 110 via a communication network 115. The performance data may identify a system performance condition in the vehicle subsystem which may require attention, whether a vehicle subsystem is operating as expected, which features of the vehicle subsystem are used most often by an occupant of the vehicle 100, or the like. The performance data may be measured by one or more sensors 120 located throughout the vehicle 100. Alternatively or in addition, one or more vehicle subsystems 125 may output the performance data associated with that subsystem. Although illustrated as a sedan, the vehicle 100 may include any passenger or commercial vehicle such as a car, a truck, a sport utility vehicle, a taxi, a bus, etc. In some possible approaches, the vehicle 100 is an autonomous vehicle configured to operate in an autonomous (e.g., driverless) mode, a partially autonomous mode, and/or a non-autonomous mode.

The remote aggregation server 110 may be configured to receive performance data from multiple vehicles 100. The remote aggregation server 110 may be implemented in a content delivery network and incorporate any number of sampling processes. Rare but significant events may be given an escalated priority, and aggregation processes may operate in general on representative sets of data. In one possible implementation, the remote aggregation server 110 may be configured to aggregate the performance data and identify one or more trends associated with one or more vehicle subsystems 125 from the performance data. The trend may be identified by the remote aggregation server 110 under certain predetermined circumstances. For instance, the trend may be identified if a particular sub-system condition (i.e., a condition which may require attention associated with one or more vehicle subsystems 125) occurs a predetermined number of times in a predetermined number of vehicles 100. The remote aggregation server 110 may be further configured to wirelessly communicate with multiple vehicles 100. For instance, the remote aggregation server 110 may be configured to transmit messages identifying the trend to multiple vehicles 100. Therefore, if a particular vehicle subsystem 125 is experiencing an unusual number of sub-system conditions which require attention or being used in an unexpected way that reduces the life of the vehicle subsystem 125, the message may recommend that the owner have the vehicle subsystem 125 serviced.

Alternatively or in addition, the performance data may identify successful operation of one or more vehicle subsystems 125. That is, the performance data may indicate whether a vehicle subsystem 125 is operating as expected. Accordingly, the trend identified by the remote aggregation server 110 may be used to test, in real -time, new features, including firmware or software, for one or more vehicle subsystems 125. For instance, using the system 105, updated software or firmware can be downloaded to vehicle subsystems 125 in a select number of vehicles 100. The performance data of those vehicle subsystems 125 with the updated software or firmware may be monitored by the remote aggregation server 110, and the trends associated with the updated software may indicate whether the updated software or firmware may be released to vehicle subsystems 125 in a larger number of vehicles 100.

Moreover, the performance data may suggest which features of vehicle subsystems 125 are most popular among drivers. For instance, the performance data may indicate which features are used most often, and the trend generated by the remote aggregation server 110 may identify which features, if any, are most and least often used. The features used most often may be prioritized for further development and updates. Features that are used least often may be removed from future versions of the vehicle subsystem 125. In addition, the trend may indicate whether a feature is not often used because the feature faults frequently or because the consumer has little interest in the feature (i.e., the feature works as expected). Features that are not often used because of a need for improved performance may be prioritized for future development and updates instead of being removed from the vehicle subsystem 125.

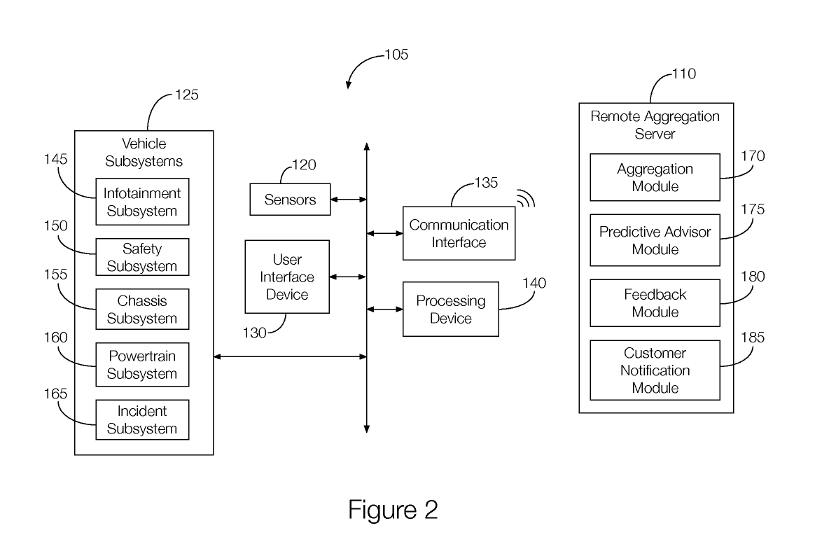

FIG. 2 illustrates a block diagram of the system 105 incorporated into the vehicle 100 as well as example components of the remote aggregation server 110. As shown, the system 105 includes a user interface device 130, a communication interface 135, and a processing device 140. The system 105, as discussed above, may be configured to receive signals output by one or more sensors 120. Alternatively or in addition, one or more vehicle subsystems 125 may output performance data. Examples of vehicle subsystems 125 are also illustrated in FIG. 2. The vehicle subsystems 125 may include an infotainment subsystem 145, a safety subsystem 150, a chassis subsystem 155, a powertrain subsystem 160, and an incident subsystem 165. The remote aggregation server 110 may include an aggregation module 170, a predictive advisor module 175, a feedback module 180, and a customer notification module 185.

The user interface device 130 may be configured to present information to a user, such as a driver, during operation of the vehicle 100. For instance, messages received from the remote aggregation server 110 (e.g., “trend messages”) identifying trends associated with one or more vehicle subsystems 125 may be presented to the driver or other occupant of the vehicle 100 via the user interface device 130. Moreover, the user interface device 130 may be configured to receive user inputs. Thus, the user interface device 130 may be located in the passenger compartment of the vehicle 100. In some possible approaches, the user interface device 130 may include a touch-sensitive display screen, a microphone for voice interactions, or any other device configured to receive structured inputs, verbatim inputs, or both.

The communication interface 135 may be configured to facilitate wired and/or wireless communication between the components of the vehicle 100 and other devices, such as the remote aggregation server 110 or even another vehicle when using, e.g., a vehicle-to-vehicle communication protocol. The communication interface 135 may be configured to receive messages from, and transmit messages to, a cellular provider's tower and the Telematics Service Delivery Network (SDN) associated with the vehicle 100 that, in turn, establishes communication with a user's mobile device such as a cell phone, a tablet computer, a laptop computer, a fob, or any other electronic device configured for wireless communication via a secondary or the same cellular provider. Cellular communication to the telematics transceiver through the SDN may also be initiated from an internet connected device such as a PC, Laptop, Notebook, or WiFi connected phone using, e.g., the Ford SYNC AppLink application, or a portable music player. The communication interface 135 may also be configured to communicate directly from the vehicle 100 to the user's remote device or any other device using any number of communication protocols such as Bluetooth®, Bluetooth® Low Energy, or WiFi. An example of a vehicle-to-vehicle communication protocol may include, e.g., the dedicated short range communication (DSRC) protocol (e.g., IEEE 802.11p, IEEE 1609.x). Accordingly, the communication interface 135 may be configured to receive messages from and/or transmit messages to the remote aggregation server 110 and/or other vehicles 100.

The processing device 140 may be configured to receive performance data from, e.g., one or more sensors 120 or vehicle subsystems 125 and generate a message that includes the performance data. The processing device 140 may, in one possible approach, combine performance data, received over a period of time, to determine whether an issue has occurred or continues to occur. The processing device 140 may employ a frequency probabilistic or summation approach and compare the frequency of the occurrence to a threshold. The threshold may be dependent on the vehicle subsystem 125 or the feature being evaluated. When the threshold is exceeded, the processing device 140 may generate the message, and in some circumstances, transmit the message to the remote aggregation server 110 via, e.g., the communication interface 135. In some possible implementations, the processing device 140 may transmit the message in response to a user input received via the user interface device 130. For instance, the driver or other occupant of the vehicle 100 may be prompted to permit the processing device 140 to transmit the message to the remote aggregation server 110. The driver or other occupant may be prompted to select whether to have the system 105 automatically generate and transmit future messages. Thus, the driver or other occupant can opt-in or opt-out of having future messages automatically generated, transmitted to the remote aggregation server 110, or both. In some possible approaches, the driver may receive rewards or other benefits for opting in, trying new features, or for affirmatively responding to the trend messages.

As discussed above, the trend messages received from the remote aggregation server 110 may be presented to the driver or other occupant of the vehicle 100 through the user interface device 130. The processing device 140 may be configured to monitor how the driver or other occupant responds to the trend message. Monitoring the driver or other occupant may include monitoring a user input. For instance, the driver or other occupant may elect, through the user interface device 130, to download new software or firmware to the vehicle subsystem 125, take the vehicle 100 to a mechanic for preventative maintenance, or, in some cases, ignore the trend message. Monitoring may further or alternatively include an indirect measurement such as voice-emotion detection, reaction testing, electro-galvanic skin response, etc.

As discussed above, the vehicle subsystems 125 may include an infotainment subsystem 145, a safety subsystem 150, a chassis subsystem 155, a powertrain subsystem 160, and an incident subsystem 165. The infotainment subsystem 145 may be configured to output performance data associated with an infotainment system. The safety subsystem 150 may be configured to output performance data associated with various safety systems incorporated into the vehicle 100. For instance, the safety subsystem 150 may be configured to evaluate a controller area network (CAN) bus for messages indicating that one or more sensors 120 is damaged or that a sub-system condition which needs attention has been detected. The chassis subsystem 155 may be configured to output performance data about elements of the vehicle chassis based on, e.g., messages transmitted through the CAN bus. The powertrain subsystem 160 may be configured to output performance data concerning powertrain systems of the vehicle 100 including engine and transmission related performance data. The powertrain subsystem 160 may generate the performance data from, e.g., messages transmitted via the CAN bus. The incident subsystem 165 may be configured to output performance data associated with other systems of the vehicle 100 or interactions between vehicle systems and subsystems 125.

As discussed above, the remote aggregation server 110 may include an aggregation module 170, a predictive advisor module 175, a feedback module 180, and a customer notification module 185.

The aggregation module 170 may be configured to accumulate performance data received from each vehicle 100. The performance data may be collected from vehicles 100 of different makes and models, and the accumulated performance data may indicate one or more trends. Thus, trends in performance data may be assessed for vehicle subsystems 125 across different types of vehicles 100 and developed by different companies.

The predictive advisor module 175 may be configured to rank the trends generated by the aggregation module 170, assign the trend to a category, or both. Statistical processes may be applied to automatically discover classes and categories of trends. Topic modeling may be used to automatically follow how classes and categories evolve over time in the data corpus. Example processes may include singular value decomposition, non-negative matrix factorization, semantic analysis, etc. The trends may be ranked in terms of severity. For instance, a trend that suggests a widespread mechanical failure of a particular vehicle subsystem 125 may be given a higher rank than a trend that suggests a relatively minor software issue. Categories of trends may be associated with the type of action necessary to address the trend. Examples of actions may include replacing a vehicle subsystem 125, recommending further development of the vehicle subsystem 125, developing a new feature of the vehicle subsystem 125, omitting a feature from future iterations of the vehicle subsystem 125, etc.

The feedback module 180 may be configured to transmit one or more notifications of the trends to particular groups, such as research and development groups, within an organization. For instance, the infotainment subsystem 145 may be associated with an infotainment group. The feedback module 180 may be configured to transmit notifications concerning trends with the infotainment subsystem 145 to the infotainment group.

The customer notification module 185 may be configured to generate and transmit a message to, or otherwise notify, the driver or other occupant of the vehicle 100 representing the trend. The message or notification may communicate the trend to the driver or other occupant, and in some possible approaches, recommend a course of action to address the trend. For instance, the message or notification may recommend that the driver or other occupant download new software or firmware to the vehicle subsystem 125 or take the vehicle 100 to a mechanic for preventative maintenance. The customer notification module 185 may be configured to communicate with, e.g., the communication interface 135 over the communication network 115. In some instances, the customer notification module 185 may also initiate a process for providing additional notifications using other means of communication, including email, a social networking application, and postal services. In addition to the driver or other occupant, notifications may be sent to a registered vehicle owner, lessor, or renter. The notifications may also be sent to a repair shop, parts distributor, governmental authority, website, or the like.

FIG. 3 is a flowchart of an example process that may be used by the remote aggregation server 110 of FIG. 1 to identify trends in the performance data relative to multiple vehicles 100.

At block 305, the remote aggregation server 110 may receive performance data from multiple vehicles 100. The performance data, as discussed above, may be associated with any number of vehicle subsystems 125, vehicle cohorts, or both. Vehicle cohorts can be discovered as described above or can be a group of vehicles using a particular component having common characteristics. For instance, the component may have come from a single supplier, may be associated with a vehicle of a model year, may have been manufactured in a particular batch, etc. The performance data may identify conditions in the vehicle subsystem 125, including whether a vehicle subsystem 125 is operating as expected, which features of the vehicle subsystem 125 are used most often by an occupant of the vehicle 100, or the like. The performance data may be measured by one or more sensors 120 located throughout the vehicle 100 or, in some instances, determined from signals output by the vehicle subsystem 125 and transmitted to the remote aggregation server 110 via, e.g., the communication interface 135 incorporated into the vehicle 100.

At block 310, the remote aggregation server 110 may aggregate the performance data. For instance, using the aggregation module 170, the remote aggregation server 110 may accumulate performance data received from each vehicle 100. As discussed above, the performance data may be collected from vehicles 100 of different makes and models, and the accumulated performance data may indicate one or more trends. Thus, trends in performance data may be assessed for vehicle subsystems 125 across different types of vehicles 100 and developed by different companies.

At block 315, the remote aggregation server 110 may identify, from the aggregated performance data, a trend associated with the vehicle subsystems 125 for multiple vehicles 100. Identifying a trend may include, e.g., determining whether a particular sub-system condition which required attention has occurred a predetermined number of times in a predetermined number of vehicles 100 or with a particular number of vehicle subsystems 125. Moreover, using the predictive advisor module 175, the remote aggregation server may rank the trends, assign each trends to a category, or both. As previously discussed, the trends may be ranked in terms of severity. Severity may include the likelihood of a future occurrence in a particular time relative to the cost of the failure. The likelihood of a future occurrence may be calculated via a survival function. For example, a high-cost failure mode may be discovered in a component and for the cohort of vehicles that are driving with the component when the survival model gives a 1% chance that the component will fail within a predetermined amount of time (e.g., 5 minutes). E-mail and phone calls may be too slow for notifying the drivers of the cohort of vehicles. Rather, an obtrusive notification may be displayed to each driver directing the vehicle to pull off the road immediately. In another example, an error in the SYNC software may be determined to cause 100% of the units to freeze in three days. This poses no threat of injury or property damage so a slower form of communication, such as an e-mail, can be sent to vehicle owners instructing them on how to update SYNC's operating system. In this example, obtrusive and instant messages may be avoided. Therefore, a trend that suggests a widespread mechanical failure of a particular vehicle subsystem 125 may be given a higher rank than a trend that suggests a relatively minor software issue, and the way the driver is notified may be based on the severity of the trend. Categories of trends may be associated with the type of action necessary to address the trend. Examples of actions may include replacing a vehicle subsystem 125, recommending further development of the vehicle subsystem 125, developing a new feature of the vehicle subsystem 125, omitting a feature from future iterations of the vehicle subsystem 125, etc.

At block 320, the remote aggregation server 110 may transmit a notification to one or more groups in an organization. Using the feedback module 180, the remote aggregation server 110 may transmit the notification to, e.g., a research and development groups. For instance, the infotainment subsystem 145 may be associated with an infotainment group. The remote aggregation server 110 may transmit notifications concerning trends with the infotainment subsystem 145 to the infotainment group.

At block 325, the remote aggregation server 110 may send a message to each vehicle 100 that is or may be affected by the trend. Through the customer notification module 185, the remote aggregation server 110 may generate and transmit a message to the driver or other occupant of the vehicle 100 representing the trend. The message may communicate the trend to the driver or other occupant, and in some possible approaches, recommend a course of action to address the trend. For instance, the message may recommend that the driver or other occupant download new software or firmware to the vehicle subsystem 125 or take the vehicle 100 to a mechanic for preventative maintenance. As discussed above, the content of the message and the way the message is communicated may be associated with the severity of the trend.

At block 330, the remote aggregation server 110 may receive compliance data. The compliance data may indicate whether a driver or other occupant of each vehicle 100 that received the message responded to the message. For instance, the driver or other occupant may elect, through the user interface device 130, to download new software or firmware to the vehicle subsystem 125, take the vehicle 100 to a mechanic for preventative maintenance, or, in some cases, ignore the trend message. The processing device 140 may transmit the driver or other occupant's response to the message to the remote aggregation server 110 as the compliance data.

In general, computing systems and/or devices may employ any of a number of computer operating systems, including, but by no means limited to, versions and/or varieties of the Ford Sync® operating system, the Microsoft Windows® operating system, the Unix operating system (e.g., the Solaris® operating system distributed by Oracle Corporation of Redwood Shores, California), the AIX UNIX operating system distributed by International Business Machines of Armonk, New York, the Linux operating system, the Mac OS X and iOS operating systems distributed by Apple Inc. of Cupertino, California, the BlackBerry OS and QNX distributed by Research In Motion of Waterloo, Canada, and the Android operating system developed by the Open Handset Alliance, AutoSar open-source from the AUTOSAR Development Partnership. Examples of computing devices include, without limitation, an on-board vehicle computer, a computer workstation, a server, a desktop, notebook, laptop, or handheld computer, or some other computing system and/or device.

Computing devices generally include computer-executable instructions, where the instructions may be executable by one or more computing devices such as those listed above. Computer-executable instructions may be compiled or interpreted from computer programs created using a variety of programming languages and/or technologies, including, without limitation, and either alone or in combination, Java™, C, C++, Visual Basic, Java Script, Perl, etc. In general, a processor (e.g., a microprocessor) receives instructions, e.g., from a memory, a computer-readable medium, etc., and executes these instructions, thereby performing one or more processes, including one or more of the processes described herein. Such instructions and other data may be stored and transmitted using a variety of computer-readable media.

A computer-readable medium (also referred to as a processor-readable medium) includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random access memory (DRAM), which typically constitutes a main memory. Such instructions may be transmitted by one or more transmission media, including coaxial cables, copper wire and fiber optics, including the wires that comprise a system bus coupled to a processor of a computer. Common forms of computer-readable media include, for example, a floppy disk, a flexible disk, hard disk, magnetic tape, any other magnetic medium, a CD-ROM, DVD, any other optical medium, punch cards, paper tape, any other physical medium with patterns of holes, a RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), a distributed database such as Cassandra from Apache Software, etc. Each such data store is generally included within a computing device employing a computer operating system such as one of those mentioned above, and are accessed via a network in any one or more of a variety of manners. A file system may be accessible from a computer operating system or a network of computers, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their ordinary meanings as understood by those knowledgeable in the technologies described herein unless an explicit indication to the contrary is made herein. In particular, use of the singular articles such as “a,” “the,” “said,” etc. should be read to recite one or more of the indicated elements unless a claim recites an explicit limitation to the contrary.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

1. A vehicle system comprising:
a communication interface; and
a processing device configured to receive performance data associated with at least one of a plurality of vehicle subsystems and generate a message that includes the performance data,
wherein the communication interface is configured to transmit the message to a remote aggregation server.

2. The vehicle system of claim 1, further comprising a user interface device configured to receive a user input.

3. The vehicle system of claim 2, wherein the processing device is configured to generate the message in response to the user input.

4. The vehicle system of claim 1, wherein the performance data includes at least one system performance condition associated with at least one of the plurality of vehicle subsystems.

5. The vehicle system of claim 1, wherein the communication interface is configured to communicate with the remote aggregation server over a communication network.

6. The vehicle system of claim 1, wherein the communication interface is configured to receive a trend message from the remote aggregation server, the trend message identifying a trend associated with at least one of the plurality of vehicle subsystems.

7. The vehicle system of claim 6, further comprising a user interface device configured to present the trend message.

8. The vehicle system of claim 1, further comprising at least one sensor configured to capture the performance data.

9. The vehicle system of claim 8, wherein the processing device is configured to receive the performance data from the at least one sensor.

10. A system comprising:
a remote aggregation server configured to receive performance data from a plurality of vehicles, wherein the performance data is associated with at least one of a plurality of vehicle subsystems,
wherein the remote aggregation server is configured to aggregate the performance data and identify a trend associated with the vehicle subsystems for a plurality of vehicles based at least in part on the performance data.

11. The system of claim 10, wherein the performance data identifies a system performance condition in at least one of the plurality of vehicle systems.

12. The system of claim 10, wherein the remote aggregation server is configured to transmit a message to each of the plurality of vehicles, wherein the message includes the trend.

13. The system of claim 10, wherein the remote aggregation server is configured to identify the trend if the performance data indicates that a particular system performance condition has occurred a predetermined number of times in a predetermined number of vehicles.

14. The system of claim 10, wherein the performance data identifies successful operation of at least one of the plurality of vehicle systems.

15. A method comprising:
receiving performance data from a plurality of vehicles, wherein the performance data is associated with at least one of a plurality of vehicle subsystems;
aggregating the performance data; and
identifying a trend associated with the vehicle subsystems for a plurality of vehicles based at least in part on the performance data.

16. The method of claim 15, wherein the performance data identifies a system performance condition in at least one of the plurality of vehicle systems.

17. The method of claim 15, further comprising transmitting a message to each of the plurality of vehicles, wherein the message includes the trend.

18. The method of claim 17, further comprising receiving compliance data indicating how a driver of each of the plurality of vehicles responded to the message.

19. The method of claim 15, wherein identifying the trend includes identifying the trend if the performance data indicates that a particular system performance condition has occurred a predetermined number of times in a predetermined number of vehicles.

20. The method of claim 15, wherein the performance data identifies successful operation of at least one of the plurality of vehicle systems.
